(19) United States
(12) Patent Application Publication
(10) Pub. No.: US 2016/0306270 A1
(43) Pub. Date: Oct. 20, 2016

(54) LIGHT SOURCE APPARATUS AND METHOD FOR GENERATING A MIXED COLOR LIGHT BEAM

(71) Applicant: Huawei Technologies Co., Ltd., Shenzhen (CN)

(72) Inventors: Nikolay Ivanovich PETROV, Shenzhen (CN); Angela Liudvigovna STOROZHEVA, Shenzhen (CN); Maksim Nikolaevich KHROMOV, Shenzhen (CN); Yury Mihaylovitch SOKOLOV, Shenzhen (CN); Vladislav Gennadievich NIKITIN, Shenzhen (CN)

(21) Appl. No.: 15/187,417

(22) Filed: Jun. 20, 2016

Related U.S. Application Data
(63) Continuation of application No. PCT/RU2013/001146, filed on Dec. 20, 2013.

(51) Int. Cl. G03B 21/20; G02B 27/30; G02B 27/14; G02B 27/10; G02B 3/00

(52) U.S. Cl. CPC G03B 21/208; G02B 27/102; G02B 3/0006; G02B 27/149; G02B 27/30; G03B 21/2013; G03B 21/2066

(57) ABSTRACT

The present application discloses a light source apparatus, which includes a first, second and third light source each configured to generate a different color light beam; a beam combining element having a first incident surface directed to the first light source, a second incident surface directed to the second light source, a third incident surface directed to the third light source and an emergent surface; and a first lenslet array placed on the first incident surface, a second lenslet array placed on the second incident surface and a third lenslet array placed on the third incident surface of the beam combining element, wherein the beam combining element is configured to combine the light beams from the first, second and third light sources into a mixed-color light beam and to emit the mixed-color light beam from the emergent surface.

### CROSS-REFERENCE TO RELATED APPLICATION

This application is a continuation of International Patent Application No. PCT/RU2013/001146, filed on Dec. 20, 2013, which is hereby incorporated by reference in its entirety.

### TECHNICAL FIELD

The present disclosure relates to a light source apparatus and a method for generating a mixed-color light beam. The disclosure further relates to the field of illumination systems, in particular pico-projector illumination systems, projection technologies, especially for increasing brightness or light efficiency.

### BACKGROUND

One of the main parts of a light projector is the illumination system. Requirements for illumination are uniformity of illumination in the image formation device and high light efficiency, i.e. ratio of emergent light intensity to light intensity from the source. A spatial light modulator (SLM) can be used as image formation device. Pico-projectors are projection systems with extremely small size, for example of only a few cm³. A further requirement for illumination systems is small size.

Dichroic X-cubes (cross cubes) are used for combination of three colour light beams, mainly red, green and blue into one mixed-colour light beam such a white light beam. Collimations, combining and homogenizing are produced by separate optical elements. Waveguides are used for transferring light to the X-cube combiner as shown in FIG. 1 illustrating the general scheme for X-cube illumination 100 with different color light sources and light guides as employed in U.S. Pat. No. 7,325,956. The cross-dichroic combiner 107 receives light through the waveguides 104, 105, 106 from the red, green and blue light emitting diodes (LEDs) 101, 102, 103 respectively and produces a mixed-color light beam. However, such scheme does not provide a satisfied uniform illumination due to light losses and decreased light efficiency of illumination. A lot of reflections into the waveguides provide further light losses. Thus, additional homogenizing optical elements are needed. FIG. 2 illustrates an illumination system 200 including waveguides with spherically formed faces and spherically formed X-cube faces as employed in U.S. Pat. No. 8,192,046. The illumination system 200 includes a light source 11, lenses 211; a color-combined medium 24; an incident surface 2111; a first light guiding surface 2112; a second light guiding surface 2121; an emergent surface 2122; a color-combined emergent surface 244; a light integration apparatus 28; a light integrated incident surface 281; and a light integrated emergent surface 282.

Each of the illumination schemes described in FIG. 1 and FIG. 2 is designed for only concrete types of LEDs, because parameters of the LED and the waveguides must correspond to each other and additional homogenization and formation of light beams can be needed. Waveguides alone do not provide a satisfied light beam. Additional homogenization is needed. Additional losses in the waveguides occur because light passing the waveguide experiences a lot of reflections. The use of solid waveguides also increases the weight of the illumination system which is critical for compact systems like pico-projectors.

It is difficult to satisfy all of these requirements together. If the illumination system shall have good light efficiency, the size of the illumination system has to be increased and vice-versa. If the illumination system shall have good uniformity, the size is big or the light efficiency is poor. All these requirements are essential for pico-projector technologies, as pico-projector technologies shall satisfy these requirements simultaneously and shall further have an extremely small size.

### SUMMARY

It is the object of the embodiment of the application to provide an improved illumination system design having high light efficiency at small size.

This object is achieved by the features of the independent claims. Further implementation forms are apparent from the dependent claims, the description and the figures.

The embodiment of the application is based on the finding that a combination of an X-cube and a lenslet array into one optical element provides improved illumination of high light efficiency at small size. Placing the lenslet array on the X-cube surfaces allows decreasing the number of optical elements in an illumination system. Therefore, it allows decreasing the size of the illumination system without optical losses. When surfaces of the X-cube are manufactured having a curve form in order to collect and direct the light collimating lenses may be excluded from the optical scheme thereby saving weight and space.

In order to describe the embodiment of the application in detail, the following terms, abbreviations and notations will be used:

SLM: spatial light modulator,

LED: light emitting diode,

PMMA: polymethylmethacrylate,

BK7: a type of borosilicate glass.

In the following, X-cube devices are described. X-cube devices are intended to combine wide red, green and blue light beams into one focussed light beam but can also provide any other mixture of colours. Diagonal surfaces of the X-cube may be covered by dichroic evaporations. In one example, red light is transmitted on one surface, green light is reflected on one diagonal surface and blue light is reflected on a second diagonal surface. The X-cube can have dichroic surfaces to form white beam light. The X-cube allows increasing light intensity because three colour light sources may be used instead of one white. Such devices are actively used in projection systems.

In the following, lenslets and lenslet arrays are described. A lenslet is a small lens that is part of a lenslet array. A lenslet array consists of a set of lenslets in the same plane. Each lenslet may usually have the same focal length. Lenslet arrays may be used to produce uniform light beams in different applications. Lenslet arrays may be implemented as flat glass plates with convex lenses, in particular spherical convex lenses having rectangular form onto an element surface. One of the main fields of application of lenslet arrays is related to illumination systems in projection technologies.

According to a first aspect, the embodiment of the application relates to a light source apparatus, comprising: a first, second and third light source each configured to generate a different color light beam; a beam combining element having a first incident surface directed to the first light source, a second incident surface directed to the second light source, a third incident surface directed to the third light source and an emergent surface; and a first lenslet array placed on the first incident surface, a second lenslet array placed on the second incident surface and a third lenslet array placed on the third incident surface of the beam combining element, wherein the beam combining element is configured to combine the light beams from the first, second and third light sources into a mixed-color light beam and to emit the mixed-color light beam from the emergent surface.

The placement of the lenslet arrays on the sides of the beam combining element implementing a combination of the beam combining element a lenslet array into one optical element. That combination provides improved illumination of high light efficiency at small size. Placing the lenslet array on the surfaces of the beam combining element allows decreasing the number of optical elements in the illumination system. Therefore, it provides a decreased the size of the illumination system without optical losses.

In a first possible implementation form of the light source apparatus according to the first aspect, an optical axis of the first, second and third lenslet array is aligned with an optical axis of the first, second and third incident surfaces, respectively.

By aligning an optical axis of the lenslet arrays with an optical axis of the respective incident surfaces, light is optimally directed to the beam combining element such that an optimal combination and mixture of light can be achieved.

In a second possible implementation form of the light source apparatus according to the first aspect as such or according to the first implementation form of the first aspect, a fourth lenslet array is placed on the emergent surface of the beam combining element.

By placing the fourth lenslet array on the emergent surface of the beam combining element, a size and weight of the beam combining element and thus the light source apparatus can be reduced without influencing the light efficiency.

In a third possible implementation form of the light source apparatus according to the first aspect as such or according to the first implementation form of the first aspect, the light source apparatus comprises a collimating lens aligned with an optical axis of the emergent surface of the beam combining element, wherein a first surface of the collimating lens facing the emergent surface of the beam combining element comprises a lenslet array placed on the first surface of the collimating lens.

By using a collimating lens on which surface a lenslet array is placed, a focus of the emitting light beam can be flexibly adjusted. By using the collimating lens, a size of the beam combining element can be reduced.

In a fourth possible implementation form of the light source apparatus according to the third implementation form of the first aspect, the first surface of the collimating lens has a planar shape and a second surface of the collimating lens opposite to the first surface has a spherical shape.

By the planar shape of the first surface, the emitting surface of the beam combining element can also have a planar shape so that the beam combining element can be easily manufactured. The spherical shape of the collimating lens provides focusing of the emergent light beam.

In a fifth possible implementation form of the light source apparatus according to the third implementation form or according to the fourth implementation form of the first aspect, the first, second and third incident surfaces of the beam combining element are spherically shaped.

The spherically shaped first, second and third incident surfaces of the beam combining element provide collimation and focusing of the light beams. When the surfaces of the beam combining element are spherically shaped additional optical elements can be saved thereby reducing the size and weight of the light source apparatus.

In a sixth possible implementation form of the light source apparatus according to the third implementation form or according to the fourth implementation form of the first aspect, the first, second and third incident surfaces of the beam combining element are planar shaped.

Planar shaped first, second and third incident surfaces of the beam combining element are easy to manufacture.

In a seventh possible implementation form of the light source apparatus according to the first aspect as such or according to the first or second implementation form of the first aspect, the first, second and third incident surfaces and the emergent surface of the beam combining element are planar shaped.

Planar shaped surfaces of the beam combining element are easy to manufacture.

In an eighth possible implementation form of the light source apparatus according to the first aspect as such or according to the first or second implementation form of the first aspect, the first, second and third incident surfaces and the emergent surface of the beam combining element are spherically shaped.

Spherically shaped surfaces of the beam combining element provide collimation and focusing of the light beams. Additional optical elements can be saved thereby reducing the size and weight of the light source apparatus.

In a ninth possible implementation form of the light source apparatus according to the eighth implementation form of the first aspect, the light source apparatus comprises a collimating lens aligned with an optical axis of the emergent surface of the beam combining element.

When a collimating lens is aligned with an optical axis of the emergent surface of the beam combining element, emerging light can be focused and losses of the emerging light can be reduced.

In a tenth possible implementation form of the light source apparatus according to the ninth implementation form of the first aspect, a first surface of the collimating lens facing the emergent surface of the beam combining element has a planar shape and a second surface of the collimating lens opposite to the first surface has a spherical shape.

By the planar shape of the first surface of the collimating lens, the emitting surface of the beam combining element can also have a planar shape so that the beam combining element can be easily manufactured. The spherical shape of the second surface of the collimating lens provides focusing of the emergent light beam.

In an eleventh possible implementation form of the light source apparatus according to the first aspect as such or according to any of the previous implementation forms of the first aspect, the beam combining element comprises a dichroic X-cube.

A dichroic X-cube provides efficient mixture of the light beams, a homogenous emerging light beam and has a small weight.

In a twelfth possible implementation form of the light source apparatus according to the first aspect as such or according to any of the previous implementation forms of the first aspect, the first, second and third light sources are arranged with respect to the beam combining element such that one of the light beams therefrom is aligned with the optical axis of the beam combining element and the two other light beams are directed perpendicular to the optical axis of the beam combining element.

When one light beam is aligned with the optical axis of the beam combining element and the two other light beams are directed perpendicular to the optical axis, the light combining element can have a simple form such as an X-cube which is easy to produce.

According to a second aspect, the embodiment of the application relates to a beam combining apparatus, comprising: a first incident surface directed to a first light source generating a first light beam; a second incident surface directed to a second light source generating a second light beam; a third incident surface directed to a third light source generating a third light beam, wherein the first, second and third light beams are different colored; and an emergent surface, wherein a first lenslet array is placed on the first incident surface, a second lenslet array is placed on the second incident surface and a third lenslet array is placed on the third incident surface of the beam combining element, and wherein the beam combining element is configured to combine the light beams from the first, second and third light sources into a mixed-color light beam and to emit the mixed-color light beam from the emergent surface.

By the placement of the lenslet arrays on the sides of the beam combining apparatus a compact optical mixer can be implemented providing improved illumination and high light efficiency at small size.

According to a third aspect, the embodiment of the application relates to a method for generating a mixed-color light beam, the method comprising: providing a first, second and third light source each light source generating a different color light beam; combining the light beams from the first, second and third light sources into a mixed-color light beam by using a beam combining element having a first incident surface directed to the first light source, a second incident surface directed to the second light source, a third incident surface directed to the third light source and an emergent surface, wherein a first lenslet array is placed on the first incident surface, a second lenslet array is placed on the second incident surface and a third lenslet array is placed on the third incident surface of the beam combining element; and emitting the mixed-color light beam from the emergent surface of the beam combining element.

Placing the lenslet array on the surfaces of the beam combining element allows decreasing the number of optical elements in the illumination system. Therefore, it decreases the size of the illumination system without significant optical losses.

The method provides improved illumination with high light efficiency at small size.

According to a further aspect, the embodiment of the application relates to a light source apparatus, comprising: a beam combining element; three light sources and multiple lenslet arrays; wherein the lenslet arrays are incorporated on incident surfaces for the three light sources, wherein an emergent surface of the beam combining element and at least one light source have collimating optics before the beam combining element.

Incorporating the lenslet arrays on incident surfaces provides a light source apparatus having high light efficiency at small size.

According to a further aspect, the embodiment of the application relates to a light source apparatus, comprising: a beam combining element; three light sources; multiple lenslet arrays and one collimating lens after the beam combing element; wherein at least one of the lenslet arrays is incorporated on an incident surface of the beam combining element for the at least one light source; wherein one of the lenslet arrays is incorporated on a surface of the collimating lens; and wherein the at least one light source has collimating optics before the beam combining element.

Incorporating at least one lenslet array on an incident surface of the beam combining element and incorporating a lenslet array on a surface of the collimating lens provides a light source apparatus having high light efficiency at small size.

According to a further aspect, the embodiment of the application relates to a light source apparatus, comprising: a beam combining element; three light sources and multiple lenslet arrays; wherein the lenslet arrays are incorporated on an incident and an emergent surface of the beam combining element; wherein the beam combining element has curved surfaces which are under a radiation of at least one of the light sources; wherein the beam combing element has a curved surface for the emergent surface; wherein part of collimating optics for the light sources are incorporated in the curved surface of the beam combining element; and wherein part of collimating optics for emergent light are incorporated in the curved surface of the beam combining element.

Incorporating a lenslet array on an incident and on an emergent surface of the beam combining element provides a light source apparatus having high light efficiency at small size.

According to a further aspect, the embodiment of the application relates to a light source apparatus, comprising: a beam combining element, three light sources, multiple lenslet arrays and a collimating optics for an emergent beam; wherein the lenslet arrays are incorporated on an incident and an emergent surface of the beam combining element; wherein the beam combining element has curved surfaces which are under a radiation of the three light sources; wherein the beam combing element has a curved surface for the emergent surface; and wherein part of the collimating optics for the light sources are incorporated in the curved surface of the beam combining element.

Incorporating part of the collimating optics for the light sources in the curved surface of the beam combining element provides a light source apparatus having high light efficiency at small size.

According to a further aspect, the embodiment of the application relates to a light source apparatus, comprising: a beam combining element, three light sources, multiple lenslet arrays and a collimating optics for an emergent beam; wherein the lenslet arrays are incorporated on an incident surface of the beam combining element; wherein the beam combining element has curved surfaces which are under a radiation of the three light sources; wherein part of the collimating optics for the light sources are incorporated in the curved surface of the beam combining element; and wherein the collimating optics for an emergent beam is incorporated with the lenslet arrays on the incident surface.

Incorporating the lenslet arrays on an incident surface of the beam combining element and incorporating part of the collimating optics for the light sources in the curved surface of the beam combining element provides a light source apparatus having high light efficiency at small size.

### BRIEF DESCRIPTION OF DRAWINGS

FIG. 1 shows a schematic diagram illustrating a general scheme for X-cube illumination 100 with different color light sources and light guides;

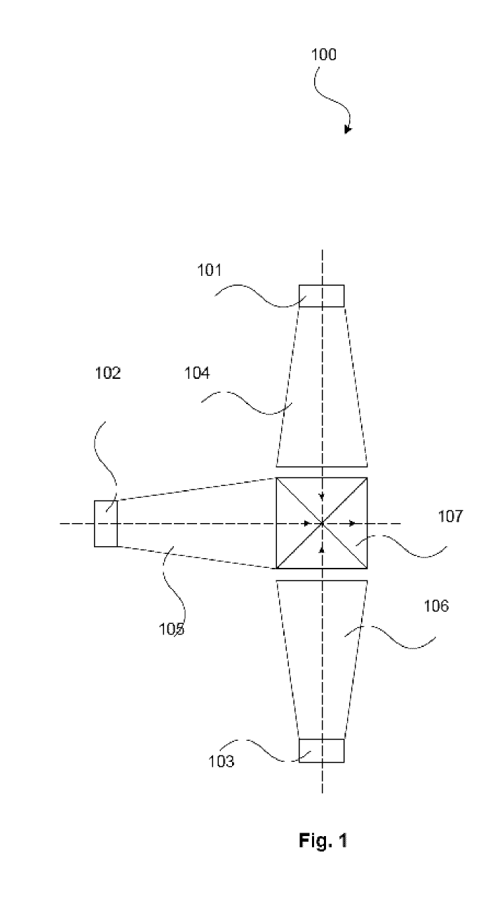

FIG. 2 shows a schematic diagram illustrating an illumination system 200 including an X-cube and waveguides with spherically formed faces;

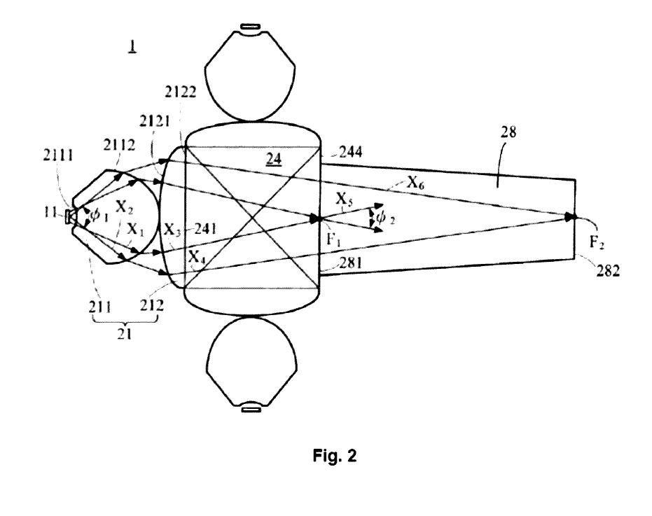

FIG. 3 shows a schematic diagram illustrating a first embodiment of an illumination system 300 including a dichroic X-cube including lenslet arrays on four planar surfaces of the X-cube;

FIG. 4 shows a schematic diagram illustrating a second embodiment of an illumination system 400 including a dichroic X-cube including lenslet arrays on three planar surfaces of the X-cube and a collimating lens including a lenslet array on one planar surface of the lenslet array;

FIG. 5 shows a schematic diagram illustrating a third embodiment of an illumination system 500 including a dichroic X-cube including lenslet arrays on four spherically formed surfaces of the X-cube;

FIG. 6 shows a schematic diagram illustrating a fourth embodiment of an illumination system 600 including a dichroic X-cube including lenslet arrays on four spherically formed surfaces of the X-cube and a collimating lens;

FIG. 7 shows a schematic diagram illustrating a fifth embodiment of an illumination system 700 including a dichroic X-cube including lenslet arrays on three spherically formed surfaces of the X-cube and a collimating lens including a lenslet array on one planar surface of the lenslet array;

FIG. 8 shows a ZEMAX simulation of the illumination system 300 depicted in FIG. 3; and

FIG. 9 shows a schematic diagram illustrating one example of a method 900 for generating a mixed-color light beam.

### DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

The devices and methods described herein may be based on illumination systems including optical X cube combiners and collimating lenses. It is understood that comments made in connection with a described method may also hold true for a corresponding device configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

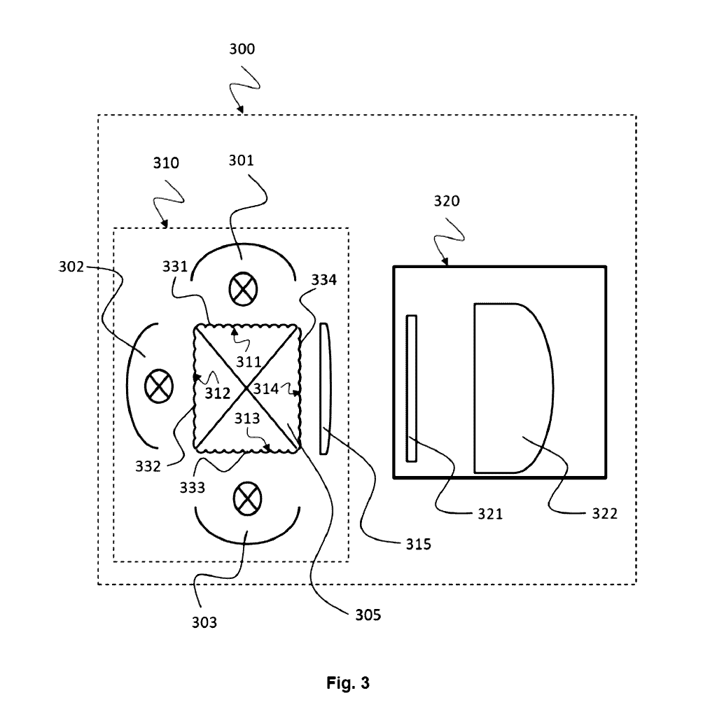

FIG. 3 shows a schematic diagram illustrating a first embodiment of an illumination system 300 including a dichroic X-cube including lenslet arrays on four planar surfaces of the X-cube.

The illumination system 300 may include a light source apparatus 310 and a projection module 320.

The light source apparatus 310 may include a first 301, second 302 and third 303 light source each of them may generate a different color light beam. The light source apparatus 310 may further include a beam combining element 305, e.g. a dichroic X-cube, with a first incident surface 311 directed to the first light source 301, a second incident surface 312 directed to the second light source 302, a third incident surface 313 directed to the third light source 303 and an emergent surface 314 directed to the projection module 320. The light source apparatus 310 may further include a first lenslet array 331 placed on the first incident surface 311, a second lenslet array 332 placed on the second incident surface 312 and a third lenslet array 333 placed on the third incident surface 313 of the beam combining element 305. The lenslet arrays may be bonded or glued on the respective surfaces or may be integrated in the respective surfaces. The beam combining element 305 may combine the light beams from the first 301, second 302 and third 303 light sources into a mixed-color light beam, e.g. a white light beam, and may emit the mixed-color light beam from the emergent surface 314.

An optical axis of the first 331, second 332 and third 333 lenslet arrays may be aligned with an optical axis of the first 311, second 312 and third 313 incident surfaces, respectively. Light passing through one of the incident surfaces passes the respective lenslet array with minimum losses. A fourth lenslet array 334 is placed on the emergent surface 314 of the beam combining element 305.

The first 311, second 312 and third 313 incident surfaces and the emergent surface 314 of the beam combining element 305 may be planar shaped. A surface being planar shaped as defined in this disclosure means that the surface is arranged on a planar plane even if the surface by itself is not necessarily planar, e.g. the micro-lenses of the lenslet array on the respective surfaces may be curved or spherically shaped. The first 301, second 302 and third 303 light sources may be arranged with respect to the beam combining element 305 such that one of the light beams therefrom is aligned with the optical axis of the beam combining element 305 and the two other light beams are directed perpendicular to the optical axis of the beam combining element 305.

In the first embodiment of the illumination system 300, the lenslet arrays 331, 332, 333, 334 may be placed on four sides or surfaces 311, 312, 313, 314 of the dichroic X-cube 305. Sides 311, 312, 313 with arrays are used for incoming of a first colour light source, e.g. green 301, a second colour light source, e.g. red 302 and a third colour light source, e.g. blue 303 but not limited to this colour scheme and the outgoing side 314 for mixed and homogenized light beams. Additional optical elements may be used for collecting light from the sources 301, 302, 303 before the X-cube 305 and an additional collimating optics such as a collimating lens 315 may be used.

The light beams from the light sources 301, 302, 303 may impinge on the corresponding lens arrays of the X-cube 305. These light beams may combine on internal dichroic surfaces of the X-cube 305 and may be focused on the external output surface 314. Thereby after the X-cube 305 the projection light beam may be homogenized and mixed. Collimating optics 5 may be used before a spatial light modulator 321. The projection module 320 may consist of the spatial light modulator 321 and a projection objective 322. The projection module 320 may form and project the needed image on a screen that is not shown here.

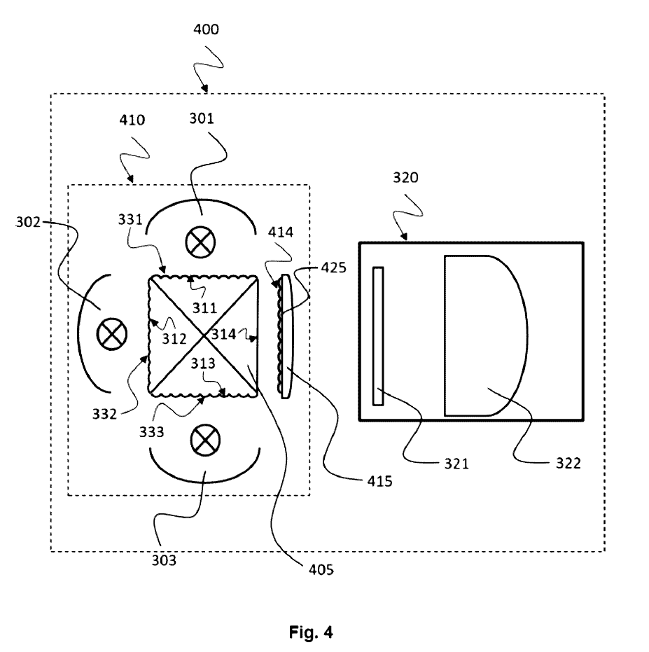

FIG. 4 shows a schematic diagram illustrating a second embodiment of an illumination system 400 including a dichroic X-cube including lenslet arrays on three planar surfaces of the X-cube and a collimating lens including a lenslet array on one planar surface of the lenslet array.

The illumination system 400 may include a light source apparatus 410 and a projection module 320 as described above with respect to FIG. 3.

The light source apparatus 410 may include a first 301, second 302 and third 303 light source each of them may generate a different color light beam. The light source apparatus 310 may further include a beam combining element 405 according to the beam combining element 305 described above with respect to FIG. 3.

The light source apparatus 410 may include a collimating lens 415 aligned with an optical axis of the emergent surface 314 of the beam combining element 405. A first surface 414 of the collimating lens 415 which faces the emergent surface 314 of the beam combining element 405 may include a lenslet array 425 placed on that first surface 414 of the collimating lens 415. The first surface 414 of the collimating lens 415 may have a planar shape. A second surface of the collimating lens 415 opposite to the first surface 414 may have a spherical shape. The first 311, second 312 and third 313 incident surfaces of the beam combining element 405 may be planar shaped.

Focal distances of the lenslet arrays may be changed relatively to the first embodiment such that optical paths are similar to the first embodiment of the illumination system 300. All other elements may be similar to the first embodiment of the illumination system 300.

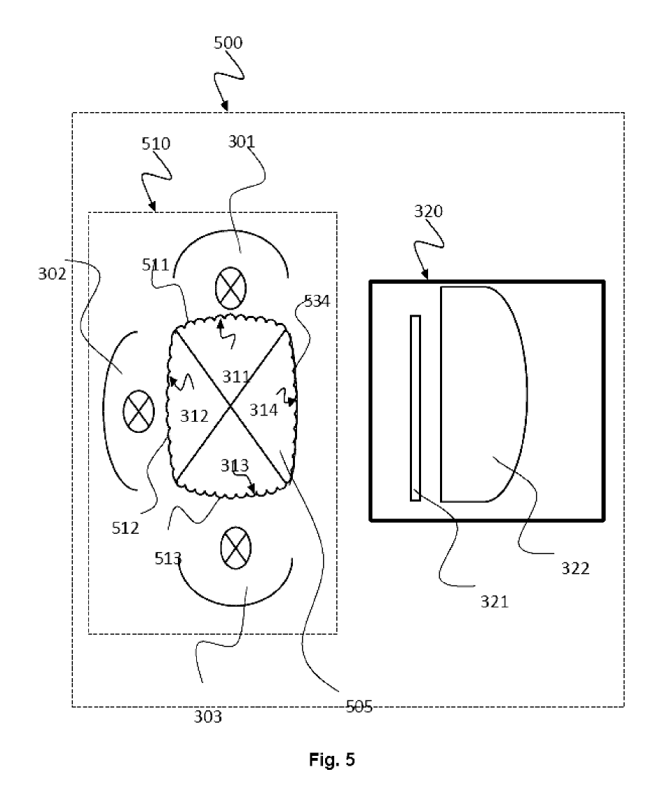

FIG. 5 shows a schematic diagram illustrating a third embodiment of an illumination system 500 including a dichroic X-cube including lenslet arrays on four spherically formed surfaces of the X-cube.

The illumination system 500 may include a light source apparatus 510 and a projection module 320 as described above with respect to FIG. 3.

The light source apparatus 510 may include a first 301, second 302 and third 303 light source each of them may generate a different color light beam. The light source apparatus 310 may further include a beam combining element 505 according to the beam combining element 305 described above with respect to FIG. 3.

An optical axis of the first 331, second 332 and third 333 lenslet array, i.e. the input lenslet arrays, may be aligned with an optical axis of the first 311, second 312 and third 313 incident surfaces, respectively. A fourth or output lenslet array 534 may be placed on the emergent surface 314 of the beam combining element 505. The first 311, second 312 and third 313 incident surfaces and the emergent surface 314 of the beam combining element 505 may be curved, e.g. spherically shaped or may have any other curvature providing a focusing of the incoming light.

The lenslet arrays 511, 512, 513 may be placed on spherical surfaces 311, 312, 313 on the sides of the X-cube combiner 505. Spherical surfaces allow to additionally collimating after the light sources 301, 302, 303 and the combiner element 505. The focal surface of the incoming lenslet arrays 511, 512, 513 may be displaced on peaks of the output lenslet array 534. By such displacement, an effective colour mixture of the incoming light sources may be achieved and the outgoing light beam may have a homogenous colour.

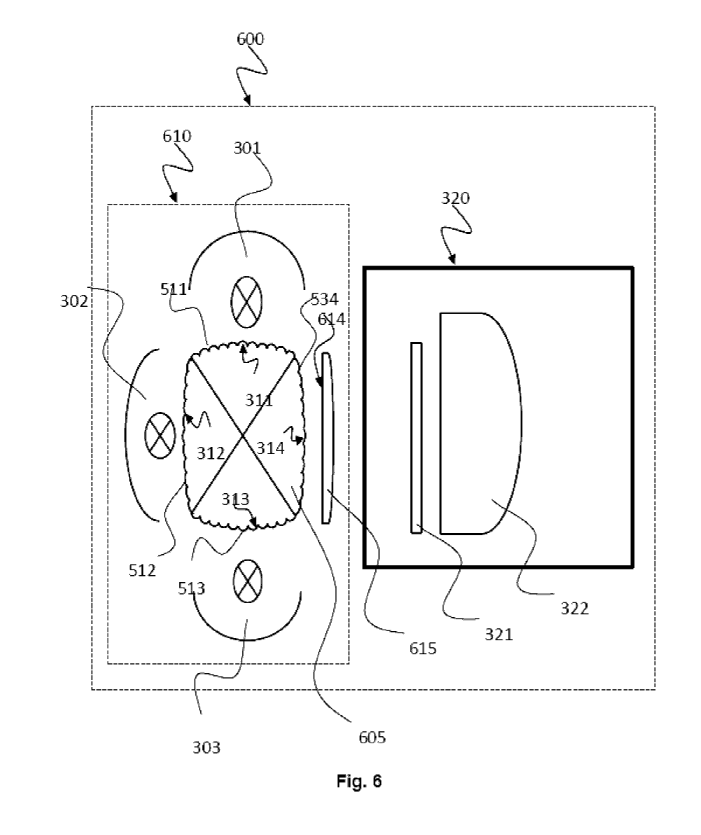

FIG. 6 shows a schematic diagram illustrating a fourth embodiment of an illumination system 600 including a dichroic X-cube including lenslet arrays on four spherically formed surfaces of the X-cube and a collimating lens.

The illumination system 600 may include a light source apparatus 610 and a projection module 320 as described above with respect to FIG. 3.

The light source apparatus 610 may include a first 301, second 302 and third 303 light source each of them may generate a different color light beam. The light source apparatus 310 may further include a beam combining element 605 according to the beam combining element 305 described above with respect to FIG. 3.

A fourth lenslet array 534 may be placed on the emergent surface 314 of the beam combining element 605. The first 311, second 312 and third 313 incident surfaces and the emergent surface 314 of the beam combining element 605 may be curved, e.g. spherically shaped. The light source apparatus 610 may include a collimating lens 615 aligned with an optical axis of the emergent surface 314 of the beam combining element 605. A first surface 614 of the collimating lens 615 facing the emergent surface 314 of the beam combining element 605 may have a planar shape and a second surface of the collimating lens 615 opposite to the first surface 614 may have a spherical shape.

In the fourth embodiment of the illumination system 600 an additional collimation lens 615 after the X-cube 605 may be utilized. Such additional collimation may provide a higher quality of light collection.

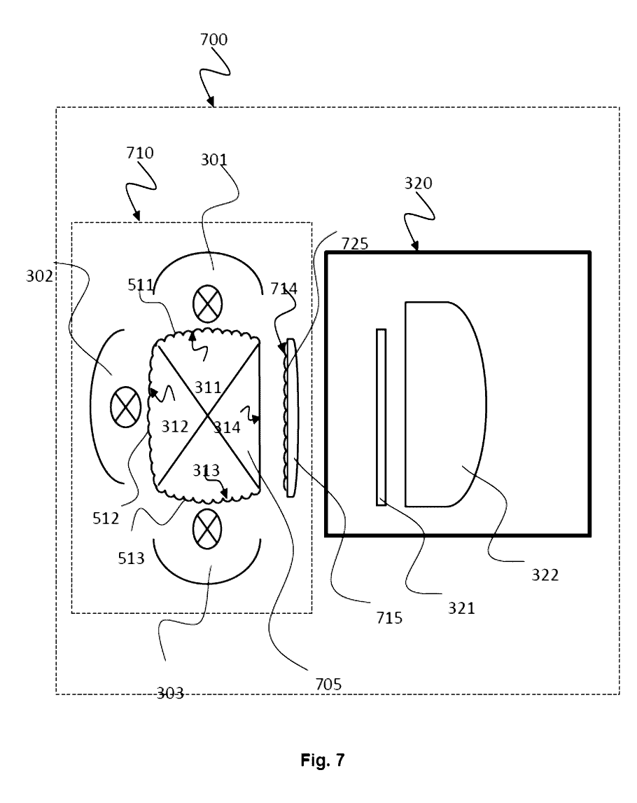

FIG. 7 shows a schematic diagram illustrating a fifth embodiment of an illumination system 700 including a dichroic X-cube including lenslet arrays on three spherically formed surfaces of the X-cube and a collimating lens including a lenslet array on one planar surface of the lenslet array.

The illumination system 700 may include a light source apparatus 710 and a projection module 320 as described above with respect to FIG. 3.

The light source apparatus 710 may include a first 301, second 302 and third 303 light source each of them may generate a different color light beam. The light source apparatus 310 may further include a beam combining element 705 according to the beam combining element 305 described above with respect to FIG. 3.

The light source apparatus 710 may include a collimating lens 715 aligned with an optical axis of the emergent surface 314 of the beam combining element 705. A first surface 714 of the collimating lens 715 facing the emergent surface 314 of the beam combining element 705 may include a lenslet array 725 placed on the first surface 714 of the collimating lens 715. The first surface 714 of the collimating lens 715 may have a planar shape and a second surface of the collimating lens 715 opposite to the first surface 714 may have a curved, e.g. spherical shape. The first 311, second 312 and third 313 incident surfaces of the beam combining element 705 may be curved, e.g. spherically shaped.

In the fifth embodiment of the illumination system 700 a secondary lenslet array may be placed on the surface of a secondary collimation lens like in the second embodiment of the illumination system 400. Utilizing this scheme allows to decrease the number of curved complex surfaces in the optical scheme.

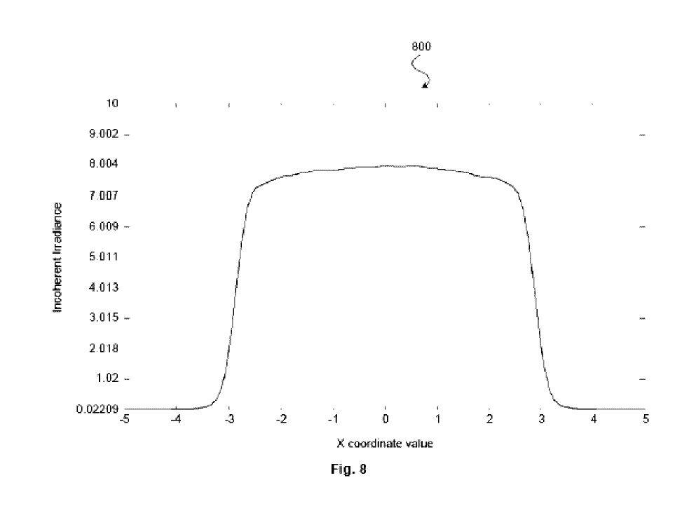

FIG. 8 shows a ZEMAX simulation of the illumination system 300 as depicted in FIG. 3.

The illumination system 300 according to the first embodiment as depicted in FIG. 3 is simulated by using a ZEMAX software, i.e. a commonly used entry-level optical design program for the design and analysis of both imaging and illumination systems. The initial red, green, blue light beams for modelling are Gaussian. A size of the X-cube with the lenslet arrays incorporated into the sides of the X-cube is 6×6×6 mm. A size of the lenslet array pitch is 0.4×0.4 mm, the radius of incoming lenslet arrays lenses is 4.5 mm (sag is equal to 4.45 μm), the radius of outgoing lenslet array lenses is 0.60625 mm (sag is equal to 34 μm). The material of the lenslet arrays is PMMA (Polymethylmethacrylate) also called acrylic glass that is a transparent thermoplastic, often used as a lightweight or shatter-resistant alternative to glass. The material of the X-cube is BK7 (borosilicate glass BK7) that is a crown glass, used in precision lenses. A total linear size of the system from back side of the X-cube to SLM is equal to 33 mm. These parameters satisfy an efficiency of greater than 70%. A size of the illuminated area was chosen to be 5×5 mm.

As can be seen from FIG. 8, uniformity is satisfied for the projection technology. The resulting light beam is sufficiently homogenous and bright. All of the embodiments allow decreasing of a number of optical components, i.e., decreasing weight, light losses into light collection and homogenizing scheme, cost of this unit and simplification of alignment of the total device.

The optical devices 310, 410, 510, 610, 710 as described above with respect to FIGS. 3 to 7 may be implemented into projection schemes that have strong requirements for size, weight, efficiency.

FIGS. 3 to 7 illustrate a beam combining element that may include a dichroic X-cube for mixing three colored light sources such as RGB (red, green, blue). The beam combining element is not limited to that colors or to a number of three colors. The beam combining element may have a different shape, for example a triangular prism, a hexagonal or octagonal prism. In one example, the beam combining element may be realized by a combination of dichroic mirrors or prisms.

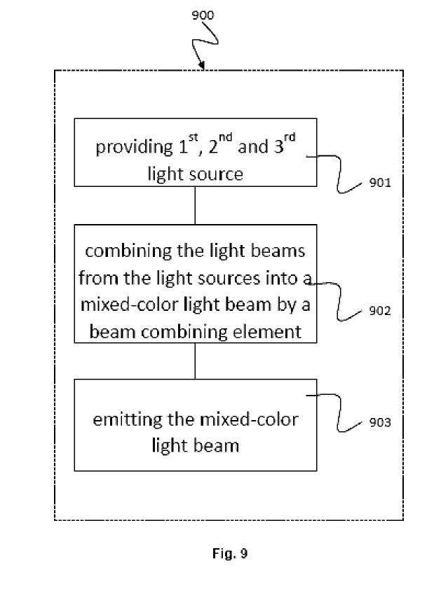

FIG. 9 shows a schematic diagram illustrating one example of a method 900 for generating a mixed-color light beam.

The method 900 may include providing 901 a first, second and third light source each light source generating a different color light beam. The method 900 may include combining 902 the light beams from the first, second and third light sources into a mixed-color light beam by using a beam combining element having a first incident surface directed to the first light source, a second incident surface directed to the second light source, a third incident surface directed to the third light source and an emergent surface, wherein a first lenslet array is placed on the first incident surface, a second lenslet array is placed on the second incident surface and a third lenslet array is placed on the third incident surface of the beam combining element. The method 900 may include emitting 903 the mixed-color light beam from the emergent surface of the beam combining element.

The method 900 may be used to operate an illumination system as described above with respect to FIGS. 3 to 7.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous embodiments of the application beyond those described herein. While the present embodiment of the application has been described with reference to one or more particular embodiments, those skilled in the art recognize that many changes may be made thereto without departing from the scope of the present embodiment of the application. It is therefore to be understood that within the scope of the appended claims and their equivalents, the embodiment of the application may be practiced otherwise than as specifically described herein.

What is claimed is:

1. A light source apparatus, comprising:
a first, second and third light source each configured to generate a different color light beam;
a beam combining element having a first incident surface directed to the first light source, a second incident surface directed to the second light source, a third incident surface directed to the third light source and an emergent surface; and
a first lenslet array placed on the first incident surface, a second lenslet array placed on the second incident surface and a third lenslet array placed on the third incident surface of the beam combining element,
wherein the beam combining element is configured to combine the different color light beams from the first, second and third light sources into a mixed-color light beam and to emit the mixed-color light beam from the emergent surface.

2. The light source apparatus of claim 1,
wherein an optical axis of the first, second and third lenslet array is aligned with an optical axis of the first, second and third incident surfaces, respectively.

3. The light source apparatus of claim 1,
wherein a fourth lenslet array is placed on the emergent surface of the beam combining element.

4. The light source apparatus of claim 1, comprising:
a collimating lens aligned with an optical axis of the emergent surface of the beam combining element, wherein a first surface of the collimating lens facing the emergent surface of the beam combining element comprises a lenslet array placed on the first surface of the collimating lens.

5. The light source apparatus of claim 4,
wherein the first surface of the collimating lens has a planar shape and a second surface of the collimating lens opposite to the first surface has a spherical shape.

6. The light source apparatus of claim 4,
wherein the first, second and third incident surfaces of the beam combining element are spherically shaped.

7. The light source apparatus of claim 4,
wherein the first, second and third incident surfaces of the beam combining element are planar shaped.

8. The light source apparatus of claim 1,
wherein the first, second and third incident surfaces and the emergent surface of the beam combining element are planar shaped.

9. The light source apparatus of claim 1,
wherein the first, second and third incident surfaces and the emergent surface of the beam combining element are spherically shaped.

10. The light source apparatus of claim 9, comprising:
a collimating lens aligned with an optical axis of the emergent surface of the beam combining element.

11. The light source apparatus of claim 10,
wherein a first surface of the collimating lens facing the emergent surface of the beam combining element has a planar shape and a second surface of the collimating lens opposite to the first surface has a spherical shape.

12. The light source apparatus of claim 1,
wherein the beam combining element comprises a dichroic X-cube.

13. The light source apparatus of claim 1,
wherein the first, second and third light sources are arranged with respect to the beam combining element such that one of the light beams therefrom is aligned with the optical axis of the beam combining element and the two other light beams are directed perpendicular to the optical axis of the beam combining element.

14. A beam combining apparatus, comprising:
a first incident surface directed to a first light source generating a first light beam;
a second incident surface directed to a second light source generating a second light beam;
a third incident surface directed to a third light source generating a third light beam, wherein the first, second and third light beams are different colored; and
an emergent surface,
wherein a first lenslet array is placed on the first incident surface, a second lenslet array is placed on the second incident surface and a third lenslet array is placed on the third incident surface of the beam combining apparatus, and
wherein the beam combining apparatus is configured to combine the different color light beams from the first, second and third light sources into a mixed-color light beam and to emit the mixed-color light beam from the emergent surface.

15. A method for generating a mixed-color light beam, the method comprising:
providing a first, second and third light source each light source generating a different color light beam;
combining the light beams from the first, second and third light sources into a mixed-color light beam by using a beam combining element having a first incident surface directed to the first light source, a second incident surface directed to the second light source, a third incident surface directed to the third light source and an emergent surface, wherein a first lenslet array is placed on the first incident surface, a second lenslet array is placed on the second incident surface and a third lenslet array is placed on the third incident surface of the beam combining element; and
emitting the mixed-color light beam from the emergent surface of the beam combining element.

16. The beam combining apparatus of claim 14,
wherein an optical axis of the first, second and third lenslet array is aligned with an optical axis of the first, second and third incident surfaces, respectively.

17. The beam combining apparatus of claim 14,
wherein a fourth lenslet array is placed on the emergent surface of the beam combining apparatus.

18. The beam combining apparatus of claim 14, comprising:
a collimating lens aligned with an optical axis of the emergent surface of the beam combining apparatus, wherein a first surface of the collimating lens facing the emergent surface of the beam combining apparatus comprises a lenslet array placed on the first surface of the collimating lens.

19. The beam combining apparatus of claim 18,
wherein the first surface of the collimating lens has a planar shape and a second surface of the collimating lens opposite to the first surface has a spherical shape.

20. The beam combining apparatus of claim 18,
wherein the first, second and third incident surfaces of the beam combining apparatus are spherically shaped.
